(19) United States
(12) Patent Application Publication
(10) Pub. No.: US 2007/0039768 A1
(43) Pub. Date: Feb. 22, 2007

(54) Balance system by fluid transfer for legged robots

(76) Inventor: Necati Hacikadiroglu, Antalya (TR)

Correspondence Address: COLLEN IP, THE HOLYOKE MANHATTAN BUILDING, 80 SOUTH HIGHLAND AVENUE, OSSINING, NY, 10562, US

(21) Appl. No.: 10/547,756

(22) PCT Filed: Mar. 13, 2003
(86) PCT No.: PCT/TR03/00016

§ 371 Date: Apr. 27, 2006

(30) Foreign Application Priority Data
Mar. 4, 2003 (TR) TR 2003/0265

(51) Int. Cl. B60K 17/16

(52) U.S. Cl. 180/76

(57) ABSTRACT

This invention is related to the balance system, for a legged robot, which prevents loss of balance during movement or performance of any job, as well as carrying weight for the robots with two or more legs. The balance system for two-legged or multi-legged robots developed in this invention is characterized by the balance fluid pumps (2), balance fluid tanks (5), balance fluid transfer canals (6) and the balance fluid (7) as the basic elements. The balance of the robot is provided by transferring the balancing fluid (7) in between the tanks (5).

This invention is related to the balance system of two-legged or multi-legged objects (robots), while moving and/or carrying weight.

It is very important in the robot sector that two-legged or multi-legged robots move without losing balance (without falling over), and execute the commands efficiently.

While moving, lifting weight or pushing objects, in order for the two-legged or multi legged robots not fall over, the projection of the center of gravity must be under the standing foot, or within the plane formed by the feet that are touching the surface.

In order to provide the balance while the two-legged or multi-legged robot is moving, the state of art requires the body to bend, to have the center of gravity under the standing foot or within the plane formed by the feet touching the surface.

One of the problems that is often seen in those multi-legged robots that keep balance by bending their body, is slow motion. In addition, the complex production process causes long production period and high production cost. Furthermore, these type of robots malfunction very often.

The main problem in two-legged robots is balance. Balance can be achieved by placing the vertical projection of the center of gravity between the two legs of the robot. According to the customary method, when raising one foot, the robot keeps its balance by bending the upper body in the opposite direction of the raised foot, thus, having the vertical projection of its center of gravity under the other (standing) foot. After the movement begins, this sense of balance continues during the whole movement, while the robot bends and/or raises its body or other extended parts, until it stops.

Another technique used for balance at the two-legged robots is hoping the robot on its feet sequentially while standing. The disadvantage of this technique is that the robot is not “walking” and that it has to jump to move forward. In addition, robot cannot keep its balance without wasting energy when it is immobile, because the robot can keep its balance only when it spends energy.

This invention aims to develop a balance system for two-legged or multi-legged robots, which provides the production of a robot, that has more balanced move, that—unlike previous versions—can carry weight and use industrial machinery, and that is able to perform all human movement functions.

Attached are the Figures submitted to explain the balance system for the two-legged and multi-legged robots, developed through this invention. The Figures in the Annex show the schematic application of the invented balance system on a two-legged robot as an example. Same system can be applied to multi-legged robots as well. The descriptions of the Figures are provided below:

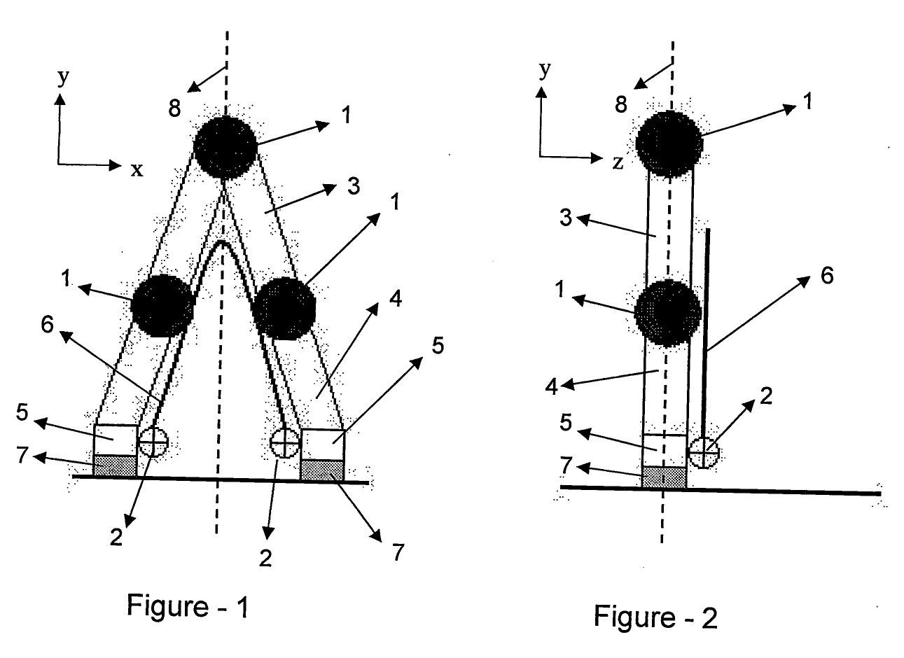

FIG. 1—The front view of the two-legged robot; standing on both feet and the balance fluid is equally distributed to both tanks.

FIG. 2—The side view of the two-legged robot; standing on both feet and the balance fluid is equally distributed to both tanks.

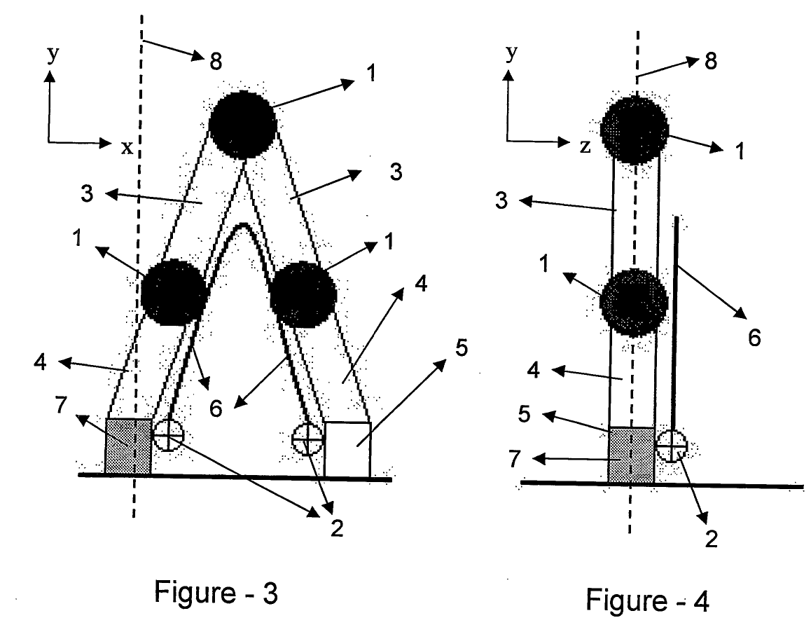

FIG. 3—The front view of the two-legged robot; standing on both feet and the balance fluid is only in one tank.

FIG. 4—The side view of the two-legged robot; standing on both feet and the balance fluid is only in one tank.

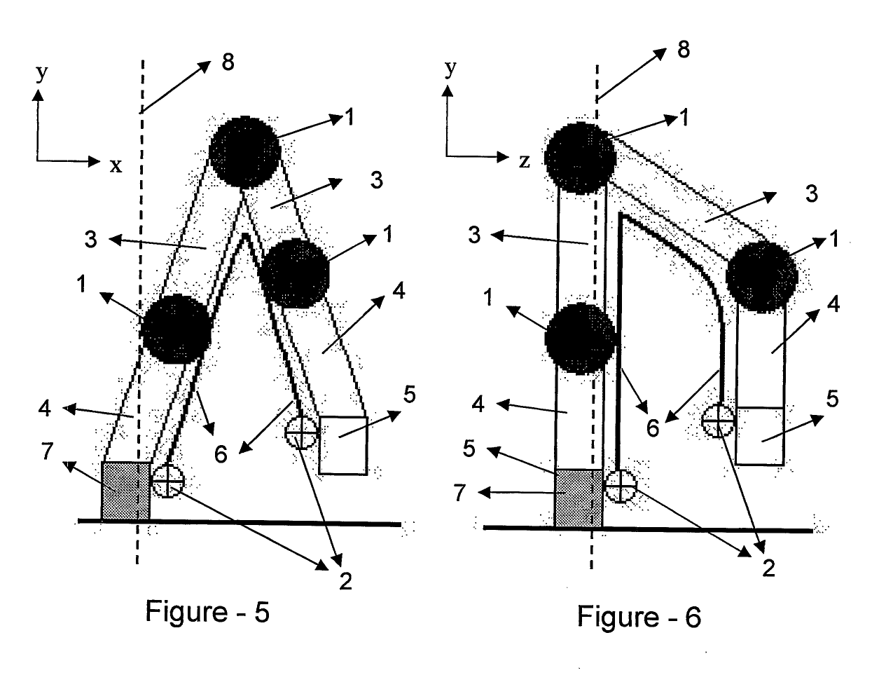

FIG. 5—The front view of the two-legged robot; the leg with empty tank has risen up (the tank is parallel to the surface, the knee is bowed)

FIG. 6—The side view of the two-legged robot; the leg with empty tank has risen up. (the tank is parallel to the surface, the knee is bowed)

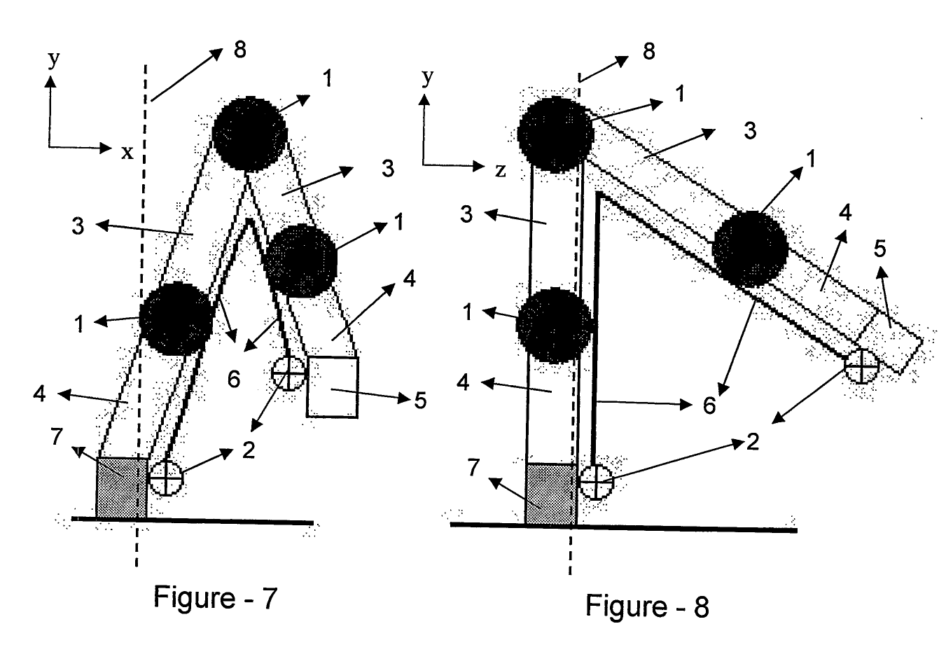

FIG. 7—The front view of the two-legged robot; the leg with empty tank has risen up (the tank is not parallel to the surface and the knee is not bowed)

FIG. 8—The side view of the two-legged robot; the leg with empty tank has risen up, (the tank is not parallel to the surface and the knee is not bowed)

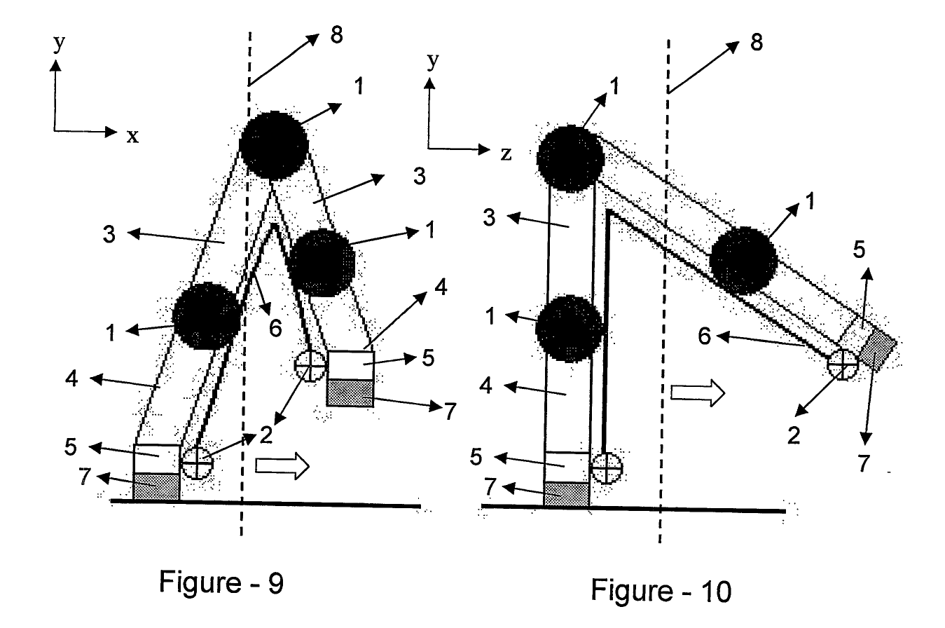

FIG. 9—The front view of the two-legged robot; the leg with empty tank is up, the balance fluid begins to flow from the standing foot with full tank to the empty one.

FIG. 10—The side view of the two-legged robot; the leg with empty tank is up, the balance fluid begins to flow from the standing foot with full tank to the empty one.

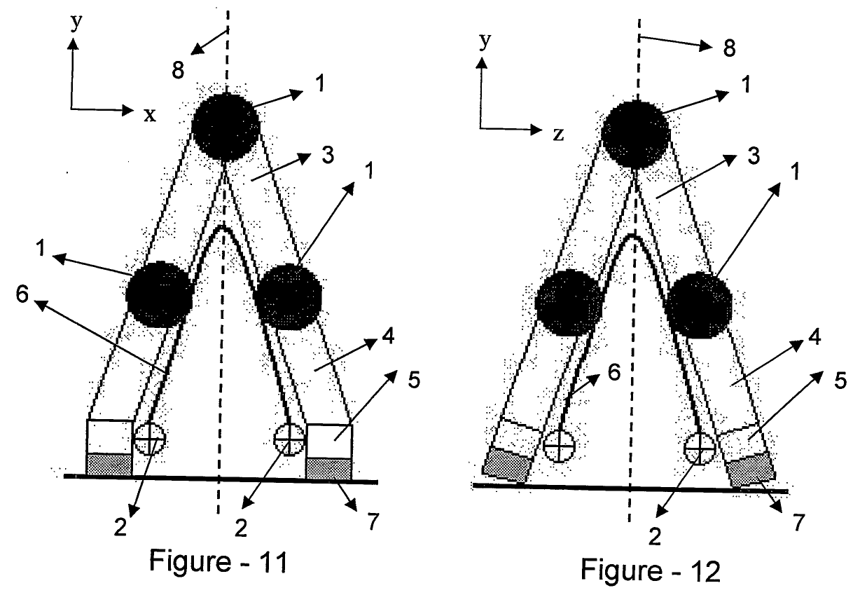

FIG. 11—The front view of the two-legged robot; standing on both feet and the balance fluid is equally distributed to both tanks.

FIG. 12—The side view of the two-legged robot; standing on both feet and the balance fluid is equally distributed to both tanks.

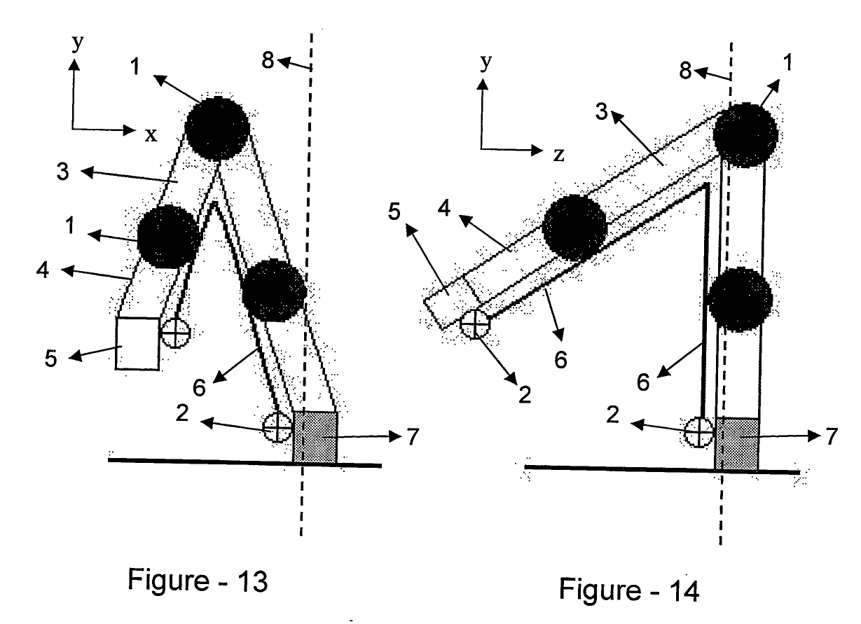

FIG. 13—The front view of the two-legged robot; standing on the foot with full tank and the foot with empty tank has risen up.

FIG. 14—The side view of the two-legged robot; standing on the foot with full tank and the foot with empty tank has risen up.

In order to better explain the balance system for two-legged of multi-legged robots in this invention, the parts appearing in the figures are numbered. Below are the explanations for each numbered part:
1—Motion motors
2—Balance fluid pumps
3—Legs (upper part)
4—Legs (lower part)
5—Balance fluid tanks
6—Balance fluid transfer canals
7—Balance fluid
8—Vertical axis of the center of gravity

The main elements of this invention of balance system for two-legged or multi-legged robots are; balance fluid pumps (2), balance fluid tanks (5), balance fluid transfer canals (6) and balance fluid (7).

Balance fluid (7) could be any liquid or gas or solid-liquid mixture or solid-gas mixture or liquid-gas mixture or solid-liquid-gas mixture or any solid (preferably in granule form) that can is transferable. Any solid that can transfer between legs can be used as Balance fluid (7). Balance fluid tanks (5) are favorable when placed at the bottom of the feet, contacting the surface. If needed, the tanks (5) can be placed at the lower leg (4) or on any part of the body. Balance fluid tanks (5) can be more than one. Balance fluid tanks (5) can be one single tank.

Balance fluid transfer canal (6) enables the transfer between the tanks (5). Balance fluid transfer canal (6) can be one or more than one. Balance fluid transfer canal (6) can be produced preferably from flexible (elastic) material. Canal (6) connects the fluid tanks (5) from inside or outside the robot, directly or passing through different parts of the body.

Balance fluid pumps (2), serves for the transfer of the fluid (7) between the tanks (5). Pumps (2) can be more than one. Balance fluid pumps (2) can be one-way or two-way pumps and/or motors.

Since the projection of the center of gravity (8) must be under the standing foot, or within the plane formed by the feet that are touching the surface, in order for the two-legged or multi legged robots not fall over while moving, lifting weight or pushing objects; this invention applies this principle by transferring the balance fluid (7) between tanks (5).

The operation of the invented balance system developed for two-legged or multi-legged robots is explained below using the attached example of the two-legged robot:

The application of the balance system on the two-legged robot includes two upper legs on both sides, (3), a motion motor (1) that connects and moves the legs back and fort, two motion motors (1) that connects a lower leg (4) to each upper leg (3) and moves the lower leg (4) back and fort, two lower legs (4), two balance fluid tanks mounted under each lower touching the surface (5), a balance fluid pump (2) that is connected to each balance fluid tank (5), and that would transfer the balance fluid (7) from one tank (5) to another, or back to the same tank (5), and a canal (6) that connects these motors and ensures the transfer of the fluid.

The axes are provided in the figures for better explanation. The horizontal axis in the direction of the two legs is the x-axis, the vertical axis is the y-axis and the orthogonal axis to the x and y-axes is named as z-axis. In the odd-numbered Figures (FIGS. 1, 3, 5, 7, 9, 11, 13), the position of the balance fluid (7) according to the motion, the change of the projection of the center of gravity on the x-axis are shown; in the even-numbered Figures (FIGS. 2, 4, 6, 8, 10, 12, 14) the change of the projection of the center of gravity on z-axis is shown.

The application of the invented balance system for the two-legged or multi-legged robots on the two-legged robots is explained below in 7 different positions. The status of the balance fluid (7) in each position is also shown.

Position 1 (FIGS. 1 and 2):

In this position, the two-legged robot is standing on its both feet. The projection of the center of gravity (8) is exactly in the middle of the line in between robot's feet as seen in the front and side views (FIG. 1 and 2). This position is named as standing position and the robot has full balance. The Balancing fluid (7) is dispersed to both tanks (5) in equal ratio, which means the amount of the fluid (7) is equal in both tanks (5).

Position 2 (FIGS. 3 and 4):

In this position the robot is ready for movement. All of the balance fluid (7) is in the tank of the leg, which will stay still. The leg with empty tank will be the one to move. The moving (i.e., walking back and fort, climbing the stairs, walking on rough surface and turning left or right) leg has no balance fluid.

In this position the projection of the center of the gravity (8) is under the area of the standing leg with full tank. Therefore the robot not only keeps its balance, but also stays balanced when the other leg begins to move.

Position 3 (FIGS. 5 and 6):

This is the first position the robot is actually moving. In this position the leg with empty fluid tank (5) is lifted up and moved by the motion motors (1). In this position, the projection of the center of the gravity (8) either does not change or is slightly changed in the front view (FIGS. 3 and 5). In the side view (FIG. 4 and 6), the projection of the center of the gravity (8) is changed towards the direction of the moving leg. At this position the robot keeps its balance because the projection of the center of the gravity (8) is still under the standing foot.

Position 4 (FIGS. 7 and 8):

In this position the leg with the empty tank (5) is risen up with the motion motors (1) to the maximum height. In this position, the projection of the center of the gravity (8) has not changed or is slightly changed in the front views FIGS. 3, 5 and 7). But in the side views (FIGS. 4, 6 and 8), it can be seen that the projection of the center of the gravity (8) has moved in the direction of moving leg. The system is still balanced, because the center of he gravity (8) still lies under the area covered by the robot's standing foot.

Position 5 (FIGS. 9 and 10):

In this position, the balance fluid (7) begins to flow from the tank (5), which is fastened to the standing leg, to the empty one (in the other leg) by the fluid pumps (2). Meanwhile the two-legged robot loses its balance and begins to fall in on its stepping foot. Hence the center of the gravity slides towards the tank (5) in which the fluid (7) has began to flow, the robot moves in the described direction without tumbling.

Position 6 (FIGS. 11 and 12):

In this position the robot finally falls on its stepping foot due to loss of balance. Both feet touch the surface. The balance fluid (7) continues to flow from one tank (in the leg which is standing) to the other (in the leg which is moving) until both tanks (5) have equal amount of fluid (7). The projection of the center of the gravity (8) is on the center of the line between its legs and the robot has balance.

Position 7 (FIGS. 13 and 14):

In this position the leg with the empty tank is raised due to the weight of the fluid and the force applied by motors (1). The projection of the center of the gravity is on the standing foot with full tank. The robot keeps its balance.

The movement of the robot is obtained with moving the leg with the empty tank in the desired direction.

The balance system for two-legged or multi-legged robots developed in this invention, can be applied to any kind of robot that can move, walk on rough/steep surface, climb stairs, carry weight, perform any job and obey the commands.

The balance system for two-legged or multi-legged robots developed in this invention can be applied to the walking units for disabled people, to the artificial legs, to the toys and to the robots that can perform every physical human action.

The balance system for two-legged or multi-legged robots developed in this invention can be applied not only to the robots with legs but also to robots with wheels.

1. A balance system for two-legged or multi-legged robots characterized by balance fluid pumps (2), balance fluid tanks (5), balance fluid transfer canals (6), balance fluid (7) as the basic elements.

2. The balance system for two-legged or multi-legged robots as claimed in claim 1 and characterized in that the balance fluid (7) is any kind of liquid, gas, solid-liquid mixture, solid-gas mixture, a liquid-gas mixture, a solid-liquid-gas mixture or any solid preferably in form of granule (powder).

3. The balance system for two-legged or multi-legged robots as claimed in claim 1 and characterized in that the balance fluid (7) is a transferable solid.

4. The balance system for two-legged or multi-legged robots as claimed in claim 1 and characterized in that the balance fluid tanks (5) are preferably placed at the bottom of the feet having contact with the surface.

5. The balance system for two-legged or multi-legged robots as claimed in claim 1 and characterized in that the balance fluid tanks (5) are placed at the lower and/or upper parts of the legs (4) and/or are placed in any preferred parts of the body of the robot.

6. The balance system for two-legged or multi-legged robots as claimed in claims 1 or 4 or 5 and characterized in that the number of the balance fluid tanks (5) is one or more 20 than one in each side.

7. The balance system for two-legged or multi-legged robots as claimed in claim 1 or 4 or 5 or 6 and characterized in that the each balance fluid tank (5) are built of a single piece.

8. The balance system for two-legged or multi-legged robots as claimed in claim 1 and characterized in that the number of the balance fluid transfer canals (6) are one or more than one, providing the transfer of the balance fluid (7) between the tanks (5).

9. The balance system for two-legged or multi-legged robots as claimed in claim 1 or 8 and characterized in that the balance fluid transfer canals (6) are produced preferably from a flexible (elastic) material.

10. The balance system for two-legged or multi-legged robots as claimed in claim 1 or 8 or 9 and characterized in that the fluid transfer canals (6) connects the fluid tanks (5) from inside or outside the robot, directly or passing through different parts of the body of the robot

11. The balance system for two-legged or multi-legged robots as claimed in claim 1 and characterized in that the number of the balancing fluid pumps (2) enables the transfer of the fluid (7) between the tanks (5) and is one or more than one.

12. The balance system for two-legged or multi-legged robots as claimed in claim 1 or 11 and characterized in that the balance fluid pumps (2) are one-way or two-way pumps and/or motors.

13. The balance system for two-legged or multi-legged robots as claimed in any one of the above claims and characterized in that the balance fluid (7) is distributed into the balancing fluid tanks (5) by supplying the condition of that the projection of the center of gravity (8) of the robot is under the standing foot or into the plane formed by the feet touching the surface.

14. The balance system for two-legged or multi-legged robots as claimed in any one of the above claims and characterized in that, when the robot is ready to move, all of the balance fluid (7) is transferred into the tanks (5) of the standing leg or legs.

15. The balance system for two-legged or multi-legged robots as claimed any one of the above claims and characterized in that the movement of the robot is supplied by moving the leg or legs with empty tanks (5) to be lifted up by the motion motors (1) and the balance fluid (7) is accumulated in the tanks (5) in the legs which are contacting to the surface, by providing the projection of the center of the gravity (8) to be under the standing foot, or at the inside the plane formed by the feet having contact with the surface.

16. The balance system for two-legged or multi-legged robots as claimed in any f the claims above and characterized in that in order for the robot to finish its movement, the balance fluid (7) should be transferred into the tanks (5) located on moving leg(s).

17. The balance system for two-legged or multi-legged robots as claimed in any of the claims above and characterized in that, it is applied to the robots with wheels.
